(19) United States
(12) Patent Application Publication
(10) Pub. No.: US 2022/0413666 A1
(43) Pub. Date: Dec. 29, 2022

(54) MESSAGE DISPLAY SYSTEM

(71) Applicant: Nicholas Ng, Tanggerang (ID)

(72) Inventor: Nicholas Ng, Tanggerang (ID)

(21) Appl. No.: 17/357,932

(22) Filed: Jun. 24, 2021

(51) Int. Cl. G06F 3/0484; G06F 3/14; G06F 40/205; G06F 40/103

(52) U.S. Cl. CPC G06F 3/0484; G06F 3/1423; G06F 40/205; G06F 40/103

(57) ABSTRACT

According to some embodiments, a message display system comprises a processor and a non-transitory computer readable medium. The non-transitory computer readable medium comprises computer-readable instructions, that when executed by the processor, perform a method. The method comprises receiving a plurality of messages from a group of users. Each of the plurality of received messages is formatted to be displayed in a moving stream of messages, and an entire received message for each of the plurality of messages is displayed in a moving stream on a display screen.

### BACKGROUND

Messaging, such as text messages or emails, is a constant and essential part any work environment. However, messaging also becomes a distraction because it takes a lot of time to open emails and messages, read each message, determine if a response is necessary, close each message and then remember where you had left off on your work. Therefore, a system that minimizes messaging distraction is desirable.

### SUMMARY

Some embodiments described herein relate to a message display system. The message display system comprises a processor and a non-transitory computer readable medium. The non-transitory computer readable medium comprises computer-readable instructions, that when executed by the processor, perform a method. The method comprises receiving a plurality of messages from a group of users. Each of the plurality of received messages is formatted to be displayed in a moving stream of messages, and an entire received message for each of the plurality of messages is displayed in a moving stream on a display screen.

### BRIEF DESCRIPTION OF THE DRAWING

FIG. 1 illustrates a display screen in accordance with some embodiments.

FIG. 2 illustrates a message stream in accordance with some embodiments.

FIG. 3 illustrates a message window in accordance with some embodiments.

FIG. 4 illustrates a streaming system in accordance with some embodiments.

FIG. 5 illustrates a method in accordance with some embodiments.

FIG. 6 illustrates a message stream in accordance with some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, and components have not been described in detail so as not to obscure the embodiments.

The present embodiments described herein relate to a novel message display system that allows messages to be streamed across a display screen (e.g., a computer screen) to minimizes messaging distraction. In particular, the present embodiments relate to a message display system that minimizes distraction in cases, for example, when a group of senders (e.g., a predetermined group of works, friends, or a friends list) frequently send messages back and forth and every message (e.g., email, direct message, text message) does not need to be fully read or responded to. For example, the message display system may be used in an office environment where a manager is copied on all messages sent from the people he manages. During the course of the day, the manager may not need to respond to every email but needs to view correspondence being sent in the case that he has to step in and respond or if there is anything that is sent directly to him.

The display system 100 comprises a message stream 110 that is shown on a display 105 and. The display 105 may comprise any computer, tablet or phone display screen. For example, the display 105 may be based on LCD or LED technology. In some embodiments, the message stream 110 may comprise a stream of messages such as, but not limited to, email messages, text messages, or direct messages. The message stream 110, may display messages from right to left or left to right depending on the language being displayed. The message stream 110 may be displayed in a moveable window so that it can be moved to a convenient location on the display 105. In some embodiments, each message in the message stream may trigger a notification sound when displayed (e.g., a ding or a pop). In some embodiments, a may be inserted between each message so that there is a visual indication of a new message by sensing movement in the stream.

For illustrative purposes, and to aid in understanding features of the specification, an example will now be introduced. This example is not intended to limit the scope of the claims. In some embodiments, a sales manager wants to receive a constant stream of messages from his sales team which comprises a team of ten individuals. The sales manager, through a graphical user interface, may select the group of people that he wants to see in his message stream. In some embodiments, the sales manager may select all employees so that all company related messages are displayed in his individual message stream 110.

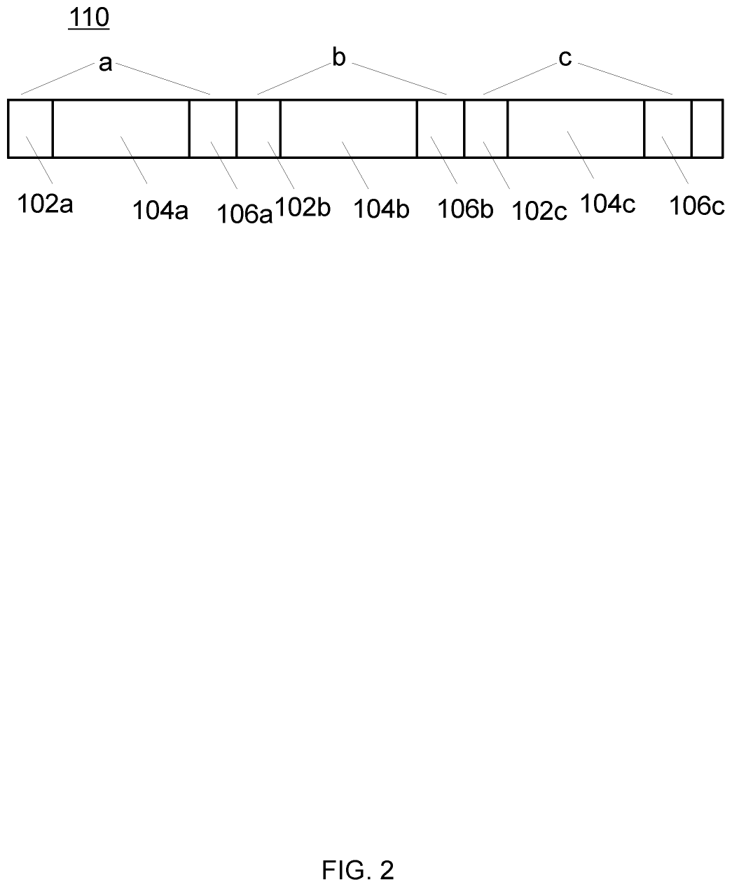

The message stream 110 may be further customized as shown in FIG. 2. FIG. 2 illustrates three different messages being sent in succession. In particular, it illustrates message “a”, message “b” and message “c” where message “a” was sent first, followed by message “b” and then followed by message “c”. Each message (a, b, c) comprises a header portion 102, a body portion 104 and a footer portion 106. Each portion (102/104/106) may be customized so that the user can minimize the amount of data displayed which may save on network bandwidth and system processor usage. It also may also make it simpler and easier for the user to view messages in the message stream to minimize distraction.

For the header portion 102, the user viewing the message stream may select to display the message sender's full name, the message sender's first name or the message sender's last name. For a small team, a manager (e.g., the user that views the stream) may not need to see the full name of the message sender in the message. Without removing information in the header portion 102, the header portion may include message address and message routing information and this may optionally be selected and displayed if desired.

For the body portion 104, the user viewing the message stream may select to display the entire body portion of the message, in some embodiments, the user may select to receive only a fraction of the body potion (e.g., the first 180 characters).

For the footer portion 104, the user viewing the message stream may select to display a signature section or forwarded information included in the message below the signature. For example, to save bandwidth, signatures and forwarded information may not be displayed. However, in cases where user viewing the message stream needs to see forwarded information, such information can be selected to a number of forwarded messages (e.g., one past message or two past messages). Again, by limiting the number of forwarded messages displayed, bandwidth usage can be reduced.

This customizable display may allow only the important aspects of the message to be displayed and thus save on the amount of data being transmitted to a user's display. Thus, an entire message displayed to a user viewing the message stream may comprise the customized message.

Continuing with the above example, the sales manager may customize his message display to only show last names of individuals, the full message in the body potion of the message, and only the most recent forwarded information. The sales manager may determine that this customization provides the required information that he needs to see streamed on his display.

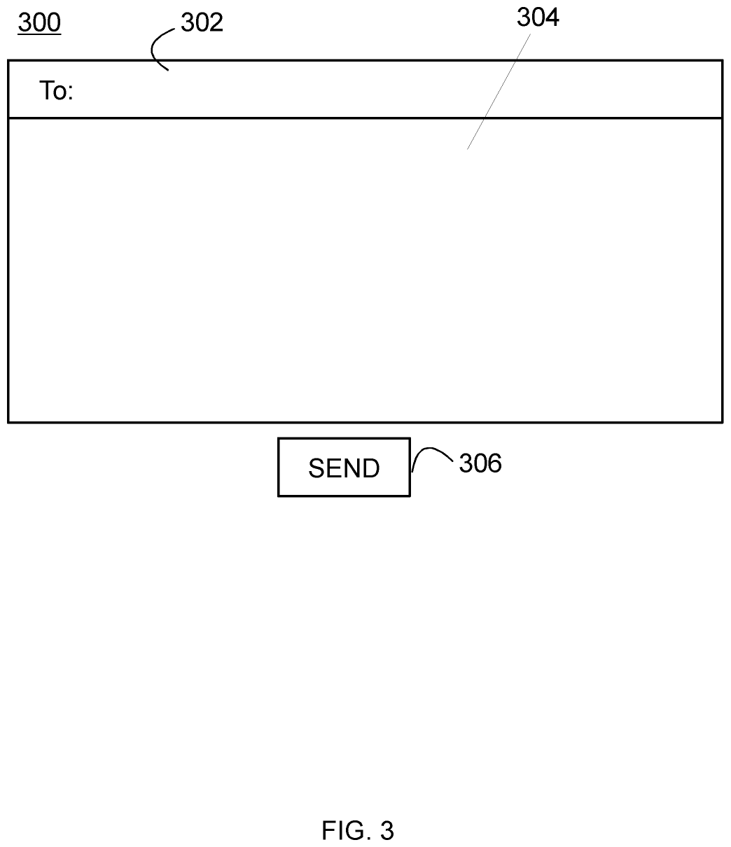

Referring now to FIG. 3, selection of a message in the message stream may cause a messaging program to be executed and a sent or reply screen to be opened up and displayed to the user viewing the message stream. The messaging program may be based on a predefined program. For example, the messaging program that is launched/executed may be (i) the same as the messaging program used by the sender of the message that is being replied to, (ii) tailored to a specific messaging program for each individual or (iii) a default messaging program, such as, but not limited to, a default program indicated on a computer, phone or tablet.

Continuing again with the above example, if message “a” is from employee Jones, and the sales manager feels that he needs to respond to message “a”, the sales manager may select (e.g., click on) message “a”. In response to the selection of message “a”, a messaging program may be executed and the messaging program may open messaging window 300. In some embodiments, the messaging window 300 may comprise a “TO” section 302 that is prepopulated with the sender of message “a”. In this case, the sales manager simply needs to type his message into the body portion 304 and hit a send or transmit button 306. A message will then be sent to the sender of message “a”.

The message program used to send a message to the sender of message “a” may be an email program that sends to sender a's email. In some embodiments, if sender “a” is travelling, a SMS message may be the default for sender “a” while he is travelling and the messaging program being executed may be a SMS messaging pogrom. In some embodiments, a unified messaging program may be displayed to the user (e.g., the sales manager) and a method of transmission (e.g., SMS texting or emailing) may be determined by a back-end system based on user settings.

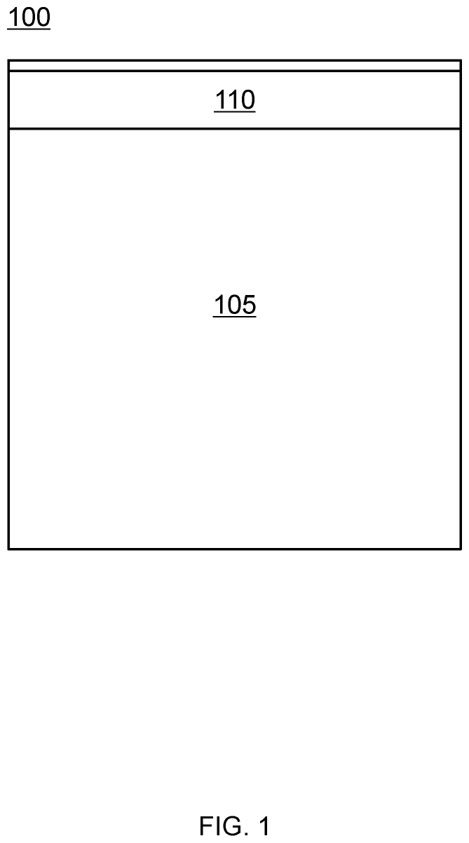

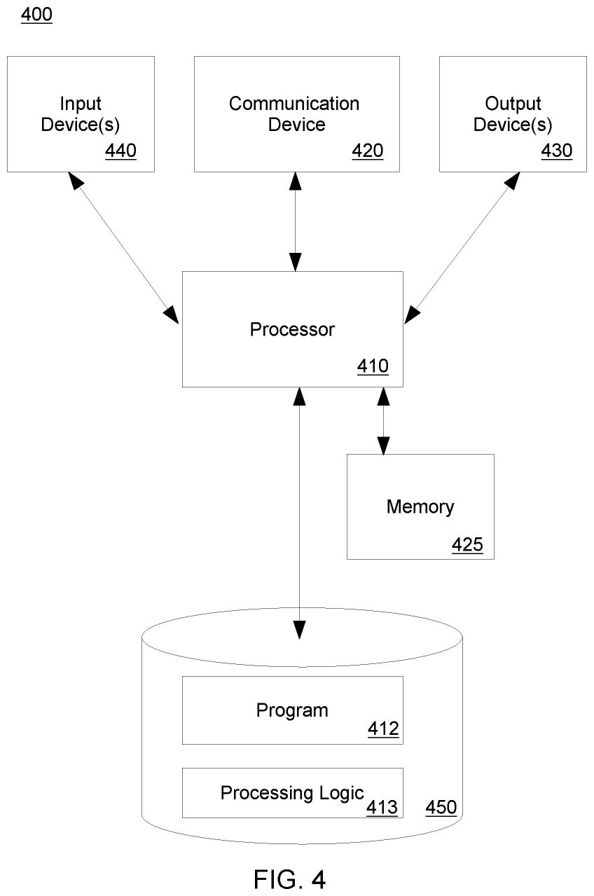

Note the embodiments described herein may be implemented using any number of different hardware configurations. For example, FIG. 4 illustrates a message display system 400 that may be, for example, associated with message display disclosed in FIG. 1 and FIG. 2. The message display system 400 may provide a technical and commercial advantage by being able to minimize both messaging distraction and network bandwidth.

The message display system 400 may comprise a processor 410 (“processor”), such as one or more commercially available Central Processing Units (CPUs) in the form of one-chip microprocessors, coupled to a communication device 420 configured to communicate via a communication network (not shown in FIG. 4). The communication device 420 may be used to communicate, for example, with one or more machines on a network. In some embodiments, the communication device 420 may comprise a network transmitter that may be selectable as a cellular transmitter, a Wi-Fi transmitter, a BLUETOOTH transmitter, or a wired network transmitter. In some embodiments, multiple communication devices 420 may be present such that the time recorder 400 comprises one or more of a cellular transmitter, a Wi-Fi transmitter, a BLUETOOTH transmitter, and a wired network transmitter. The message display system 400 further includes an input device 440 (e.g., a mouse, touch pad and/or keyboard to enter information about a user and/or one or more biometric sensors) and an output device 430 (e.g., to output and display data and/or alerts) such as a display screen.

The processor 410 also communicates with a memory 425 and storage device 450 that stores data 413. The storage device 350 may comprise any appropriate information storage device, including combinations of magnetic storage devices (e.g., a hard disk drive), optical storage devices, mobile telephones, and/or semiconductor memory devices. The storage device 450 may store a program 412 and/or processing logic 413 for controlling the processor 410. The processor 410 performs instructions of the programs 412, 413, and thereby operates in accordance with any of the embodiments described herein. For example, the processor 410 may receive information associated with messages and may display the messages via the instructions of the programs 412 and processing logic 413.

The programs 412, 413 may be stored in a compiled, compressed, uncompiled and/or encrypted format or a combination. The programs 412, 413 may furthermore include other program elements, such as an operating system, a database management system, and/or device drivers used by the processor 410 to interface with peripheral devices.

As will be appreciated by one skilled in the art, some or all of the present embodiments may be embodied as a system, method or computer program product. Accordingly, the embodiments described herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the embodiments described herein may take the form of a computer program product embodied in one or more computer readable medium(s) having computer readable program code embodied thereon.

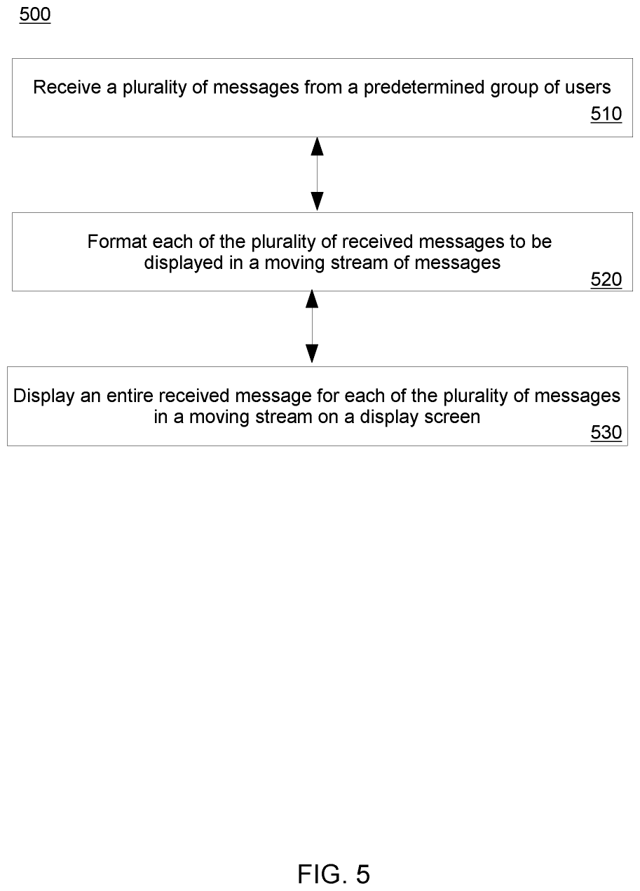

Now referring to FIG. 5, a method 500 that might be performed by a message display system, such as system described with respect to FIG. 1 and FIG. 2. The method described herein does not imply a fixed order to the steps, and embodiments described herein may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

Method 500 may relate to implementing a messaging system that streams messages across a user's display screen based on user preferences. Now referring to 510, a plurality of messages may be received from a predetermined group of users. The predetermined group may comprise, but is not limited to, a group managed by a particular individual, a customized group of individual, or may be limited to a company's employees. Next, at 520, each of the plurality of received messages may be formatted to be displayed in a moving stream of messages. Formatting may comprise, but is not limited to, serializing the received message to be put in a data stream, and parsing the received message to only display data based on user preferences that is to be sent to a display. At 530, an entire received message for each of the plurality of messages is displayed in a moving stream on a display screen. The stream may display messages starting from the right or left depending on the language used. The entire received message may comprise a message with a complete message body but with reduced header and footer information to save on bandwidth and to make it easier for a user to read the information.

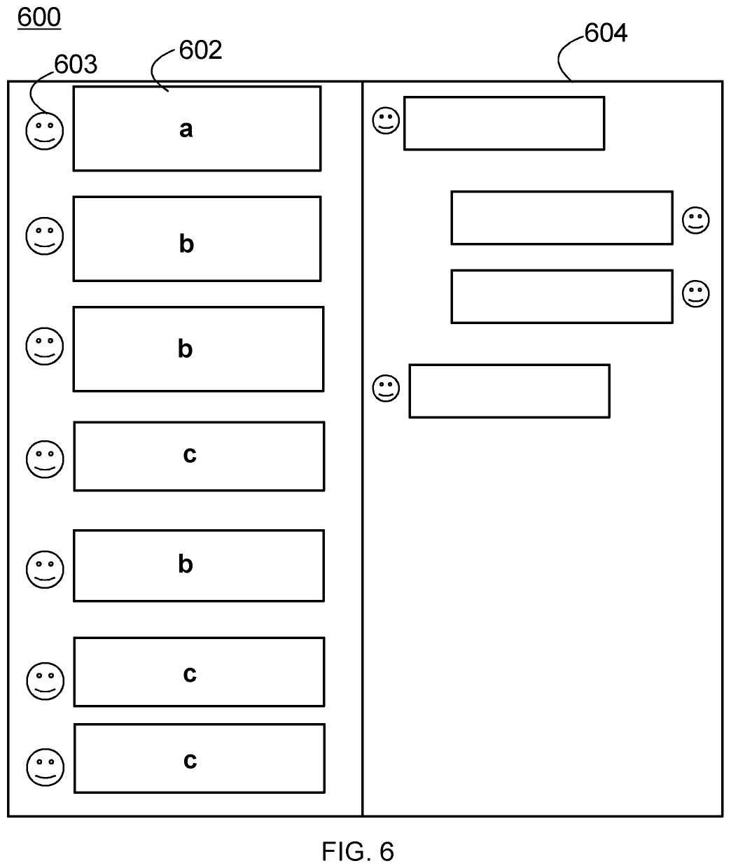

Now referring to FIG. 6, an embodiment of a message stream window 600 is illustrated. The message stream window 600 may comprise both a message stream 602 and an individual chat window 604. In the present embodiment, the message stream 602 may scroll up or scroll down based on a user's preference whenever a new message arrives. In some embodiments, when the message stream 602 functions as a user list, the message stream may not scroll and the stream will simply show the entire last message sent by a user.

In some embodiments, the message stream allows a user to view all arriving messages in a first in, first shown, style stream. In this embodiment, if a sender sends multiple messages one after another (e.g., 3 messages) then the user may view three independent messages in the stream instead of only showing the last message from the sender. In some embodiments, the multiple messages may be from a same user or from two or more different users.

Like the previously described embodiments, the message stream 602 may display an entire message instead of only a partial message like prior art systems. In some embodiments, instead of a user name, an icon 603 or photograph of the sender may be indicated in the message stream 602 and or the individual chat window 604. In the present embodiment, message stream 602 illustrates message “a”, message “b” and message “c” where message “c” was sent first, followed by message “b” and then followed by message “a”. In the embodiment that all arriving messages are in a first in, first shown, style stream, message “a” could be from a first sender, message “b” could be from a second sender and message c could also be from the second sender. In this embodiment, if a sender sends multiple messages one after another (e.g., 2 messages) then the user may view three independent messages in the stream instead of only showing the last message from the sender. In some embodiments, the three independent messages may be from a same user or from two or more different users (e.g., thee different users).

In some embodiments, message stream 602 may also serve as a user list as indicated previously. Clicking or selecting a message in the message stream 602 may allow the user to chat (1:1) in a separate window (e.g., chat window 604). Unlike prior art chat messaging systems, the present embodiments may only display a last message that a sender sends to the user. In this way, a user can view every message at a single glance and select the one(s) that need a response.

The process flow and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should be noted that any of the methods described herein can include an additional step of providing a system comprising distinct software modules embodied on a computer readable storage medium; the modules can include, for example, any or all of the elements depicted in the block diagrams and/or described herein. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

A traditional messaging system's main page may function as follows: Message senders may be individually assigned a folder, allocated to a list, which may be located on a main screen of the chat application. Messages sent from Message senders may be sorted directly to the user's folder. The last message from the message sender may be shown on the display, thus, if three subsequent messages are sent, only the last message is able to be seen by the user.

A message sender's folder may be displayed sorted by the latest message to come in, depending on the setup, either the bottom or top of the screen. Clicking on the Message sender's folder may take user to a 1:1 chat view that shows the trail of messages that the user and the Message sender have been messaging each other. User can respond and thus create text conversation with the message sender in a 1:1 fashion.

A chat stream is different than the main screen of the chat application. The chat stream may comprise a separate type of display that will show “all” messages that are not organized and separated like the traditional main page view. A chat stream may be a choice for the user to set either if user wants to see the main screen (traditional) message sender folders, or the chat stream.

In some embodiments, message senders send a message and the application receives the message, but instead of organizing the message sender's messages to show only on the message sender's folder, and to display a summary of the last message the message senders sent, the chat stream does not allocate the messages to a folder, but instead shows every message sorted by the latest one on top or the bottom depending on the setting.

The message stream may comprise all messages sent by any message senders with all messages shown in the first in first shown, last message being on the top or bottom depending on the setting.

Therefore, instead of viewing messages from sender a, b or c, despite of multiple messages sent by the message sender, the chat stream may show messages from the sender in this sequence a, b, b, c, b, c, c instead due to the different method used to display messages in the chat stream, showing all messages from senders at the same time and not organizing them according to the message sender's folder.

Also, depending on the setting, the message itself can be shown in whole, or shortened to show 2 lines depending on the setting. This may allow the user to view the messages as if they are chatting 1:1, but instead 1:many as all the messages that may be meant to be viewed 1:1 is all displayed in a single chat stream.

In some embodiments, there is no interaction in the chat stream other than scrolling to view messages that may be pushed out of the screen from incoming new messages. Clicking on a particular message will take user to the 1:1 chat view that may enable the user to type a response for the particular message sender.

This written description uses examples to disclose multiple embodiments, including the preferred embodiments, and also to enable any person skilled in the art to practice the invention, including making and using any devices or systems and performing any incorporated methods. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed is:

1. A message display system comprising:
a processor; and
a non-transitory computer readable medium, comprising computer-readable instructions, that when executed by the processor, perform a method, the method comprising:
receiving a plurality of text messages from a group of users comprising two or more users;
formatting each of the plurality of received text messages to be displayed in a moving stream of messages by serializing each of the plurality of received text messages to be put in the stream of text messages as a plurality of complete text messages;
displaying the plurality of complete text messages from two or more users in a moving stream on a display screen in a first in, first shown, top-to-bottom or bottom-to-top stream; and
pushing out an oldest of the plurality of complete messages from the display screen when a new incoming complete message arrives.

2. The message display system of claim 1, wherein the method further comprises: receiving, from a first individual, a first complete received message of the plurality of received messages in the moving stream; and
opening a message application to respond to the first complete received message.

3. The message display system of claim 2, wherein opening a message application to respond to the first complete received message comprising selecting the first complete received message of the plurality of received messages in the moving stream.

4. The message display system of claim 3, wherein selecting the first entire received message of the plurality of received messages in the moving stream executes the message application.

5. The message display system of claim 1, wherein formatting each of the plurality of received messages to be displayed in a moving stream of messages comprising parsing each message to capture sender information and message body information.

6. The message display system of claim 2, wherein the entire received message comprises the captured sender information and message body information.

7. A non-transitory computer readable medium, comprising computer-readable instructions, that when executed by the processor, perform a method, the method comprising:
receiving a plurality of text messages from a group of users comprising two or more users:
formatting each of the plurality of received text messages to be displayed in a moving stream of messages by serializing each of the plurality of received text messages to be put in the stream of text messages as a plurality of complete text messages;
displaying the plurality of complete text messages from two or more users in a moving stream on a display screen in a first in, first shown, top-to-bottom or bottom-to-top stream; and
pushing out an oldest of the plurality of complete messages from the display screen when a new incoming complete message arrives.

8. The computer readable medium of claim 7, wherein the method further comprises:
receiving, from a first individual, a first entire received message of the plurality of received messages in the moving stream; and
opening a message application to respond to the first entire received message.

9. The computer readable medium of claim 8, wherein opening a message application to respond to the first entire received message comprising selecting the first entire received message of the plurality of received messages in the moving stream.

10. The computer readable medium of claim 9, wherein selecting the first entire received message of the plurality of received messages in the moving stream executes the message application.

11. The computer readable medium of claim 7, wherein formatting each of the plurality of received messages to be displayed in a moving stream of messages comprising parsing each message to capture sender information and message body information.

12. The computer readable medium of claim 8, wherein the entire received message comprises the captured sender information and message body information.

13. The of claim 1, wherein the plurality of received text messages comprises SMS text messages.

14. The of claim 1, wherein the plurality of received text messages comprises instant messages.

15. The medium of claim 7, wherein the plurality of received text messages comprises SMS text messages.

16. The medium of claim 7, wherein the plurality of received text messages comprises instant messages.
